(19) United States
(12) Patent Application Publication
(10) Pub. No.: US 2025/0356497 A1
(43) Pub. Date: Nov. 20, 2025

(54) MULTI-VIEW MACHINE LEARNING FOR BIOLOGICAL SPECTRAL UNMIXING OF FLUOROPHORES IN FLUORESCENCE MICROSCOPY

(71) Applicant: The Research Foundation for the State University of New York, Albany, NY (US)

(72) Inventors: Alex Valm, Albany, NY (US); Yunlong Feng, Albany, NY (US); Ruogu Wang, Albany, NY (US)

(21) Appl. No.: 19/208,831

(22) Filed: May 15, 2025

Related U.S. Application Data
(60) Provisional application No. 63/647,671, filed on May 15, 2024.

(51) Int. Cl. G06T 7/11; G06T 7/90

(52) U.S. Cl. CPC G06T 7/11; G06T 7/90; G06T 2207/10056; G06T 2207/10064; G06T 2207/20081; G06T 2207/30024

(57) ABSTRACT

A system, method, and device for spectral unmixing of fluorophores in an diagnostic image of a biological sample by creating a learning model that is tuned using a training series of bacterial fluorophore images. The learning model produces an endmember matrix of excitation wavelengths for each fluorophore in each of the training series of bacterial fluorophore images. A microscope provides at least one diagnostic image of bacterial fluorophores and a computer platform, such as a processor, performs spectral unmixing on the diagnostic image by extracting an endmember of each fluorophore from the endmember matrix produced by the training series and using the extracted endmembers to learn abundances in a multi-view spectral image of the diagnostic image.

### CROSS-REFERENCE TO RELATED APPLICATION

This invention claims the benefit of U.S. Provisional Patent Application No. 63/647,671, filed on May 15, 2024, the entirety of which is hereby incorporated herein by this reference.

### STATEMENT REGARDING FEDERALLY SPONSORED RESEARCH

This invention was made with government support under grant number DMS2111080, awarded by the National Science Foundation, and grant numbers DE028042 and DE030927 awarded by the National Institute of Health. The government has certain rights in the invention.

### BACKGROUND OF THE INVENTION

### 1. Field of the Invention

The present invention generally relates to biological florescence microscopy. More particularly, the present invention relates to a system and method for using machine learning to assign fluorophore identity and abundance in a biological sample.

### 2. Description of the Related Art

Numerous biological systems exhibit intricate interactions among various subcomponents, and fluorescent labels are often employed to indicate the spatial distribution of these components within cells and tissues. Spectral imaging microscopes record fluorescence intensity data in discrete wavelength bands at each pixel, enabling the creation of a 3-dimensional data cube that integrates spatial and spectral information from the sample. While many spectrally variant fluorescent reporters are suitable for biological imaging, available fluorophores have broad excitation and emission spectra which makes distinguishing their individual contributions at every pixel a major challenge. When there is overlap in the excitation and emission spectra of fluorophores, a single excitation wavelength band may excite more than one fluorophore and the emitted signals from different fluorophores can be recorded in the same emission bands. These phenomena are known as cross-talk and bleedthrough lead to inaccurate classification and quantification of signals from different fluorophores and thus hampers the ability to localize specific biological structures or molecules within cells and tissues. To overcome these issues, spectral imaging acquisition and analysis techniques, especially spectral unmixing methods, have been developed.

These approaches aim to extract the spectral signatures of fluorophores from recorded images and determine the abundance of each fluorophore in every pixel. To tackle unmixing problems in different scenarios, various regularized learning methods have been developed. From a machine learning perspective, these methods essentially represent single-view learning where models are trained and predictions are made based on a single group of features that describe the field of interest, i.e., the emitted spectral profile of the fluorophores. However, organic fluorophores have not only unique emission spectral signatures but also possess unique excitation spectral profiles. By recording the emission spectra with multiple combinations of excitation wavelengths in the same field, one can obtain multi-view data, each view of which can be considered as a distinct feature group of the field. Accordingly, it is to this biological spectral unmixing problem that the present invention is primarily directed.

### BRIEF SUMMARY OF THE INVENTION

Briefly described, the present invention provides a generalized multi-view machine learning approach, which makes use of both excitation and emission spectra to greatly improve the accuracy in differentiating multiple highly overlapping fluorophores in a single image. By recording emission spectra of the same field with multiple combinations of excitation wavelengths, one can obtain data representing these different views of the underlying fluorophore distribution in the sample. The present framework of multi-view machine learning methods allows one to flexibly incorporate noise information and abundance constraints, to extract the spectral signatures of fluorophores from their reference images and to efficiently recover their corresponding abundances in unknown mixed images. In particular, the framework for multi-view learning in biological spectral unmixing is essentially a form of regularized learning that allows the incorporation of various noise, spatial, and sparsity constraints or other types of prior information about the fluorescent image.

In one embodiment, the invention provides a system for spectral unmixing of fluorophores in an image of a biological sample including a computer platform having at least one processor configured to implement a learning model, and the learning model is tuned using a training series of bacterial fluorophore images, and the learning model producing an endmember matrix of excitation wavelengths for each fluorophore in each of the training series of bacterial fluorophore images. There is a microscope providing at least one diagnostic image of bacterial fluorophores to the at least one processor at the computer platform, and upon receiving the at least one diagnostic image, the at least one processor performs spectral unmixing on the at least one diagnostic image by extracting an endmember of each fluorophore from the endmember matrix produced by the training series, and using the extracted endmembers to learn abundances in a multi-view spectral image of the at least one diagnostic image.

The training series of bacterial fluorophore images can be recorded at different views of bacteria. The processor can further perform linear unmixing of the diagnostic image with a Multi-View Linear Mixture Model (MV-LMM). Further, the learning model can be further tuned by an Alternating Direction Method of Multipliers (ADMM) technique. And the extracting an endmember of each fluorophore from the training series is extracting the endmember through a multi-view machine learning scheme.

The processor can further perform a loss function within extracting the endmember, the loss function from one or both of a Poisson loss and an expectile loss. The processor can be further configured to perform single-view learning in the learning model. Additionally, the processor can further perform single-view learning by using a Matrix Factorization Algorithm for endmember extraction and then using a Nonnegative Least Squares (NLS) unmixing method for abundance estimation. The endmembers can be generated using a Gaussian distribution. Additionally, the training series of bacterial fluorophore images are each comprised of a plurality of pixels and the processor can further determine, per pixel, if an estimated abundance of a corresponding fluorophore is more than that of all other fluorophores.

In an embodiment, the invention includes a method for spectral unmixing of fluorophores in an image of a biological sample with the steps of tuning a learning model using a training series of bacterial fluorophore images, with the learning model producing an endmember matrix of excitation wavelengths for each fluorophore in each of the training series of bacterial fluorophore images, and then providing at least one diagnostic image of bacterial fluorophores from a microscope. The method continues by extracting an endmember of each fluorophore from the endmember matrix produced by the training series, and then using the extracted endmembers to learn abundances in a multi-view spectral image of the at least one diagnostic image.

In one embodiment, the invention includes a device that spectrally unmixes fluorophores in an image of a biological sample, with the device having a processor configured to implement a learning model, the learning model tuned using a training series of bacterial fluorophore images, and the learning model producing an endmember matrix of excitation wavelengths for each fluorophore in each of the training series of bacterial fluorophore images. The device includes a microscopic imager providing at least one diagnostic image of bacterial fluorophores to the processor and, upon receiving the at least one diagnostic image, the processor further configured to perform spectral unmixing on the at least one diagnostic image by extracting an endmember of each fluorophore from the endmember matrix produced by the training series and using the extracted endmembers to learn abundances in a multi-view spectral image of the at least one diagnostic image.

The present invention accordingly provides an advantage in the interpretation of bacterial concentrations in biological samples. The present invention is industrially applicably in that it provides a computer device that can use a learning model to better determine bacterial concentrations in a medically diagnostic human biological sample. Other objects, features and advantages of the present invention will be apparent to one of skill in the art after review of the present application.

### BRIEF DESCRIPTION OF THE DRAWINGS

FIG. 1 is a diagram of one embodiment of a system for spectral unmixing of fluorophores in an image of a biological sample.

FIG. 2 is graph of 100 endmembers with 32 channels created through a Gaussian distribution.

FIG. 3 is a graph of boxplots of Root Mean Square Errors (RMSEs) of unmixing results.

FIG. 4A is a graph of standardized overlapping excitation spectra of 12 Fluorophores.

FIG. 4B is a graph of standardized overlapping emission spectra of 12 Fluorophores

FIG. 5 is a series of reference images of abundances.

FIG. 6 is a series of images of abundances of mixed E. Coli spectral images.

### DETAILED DESCRIPTION OF THE INVENTION

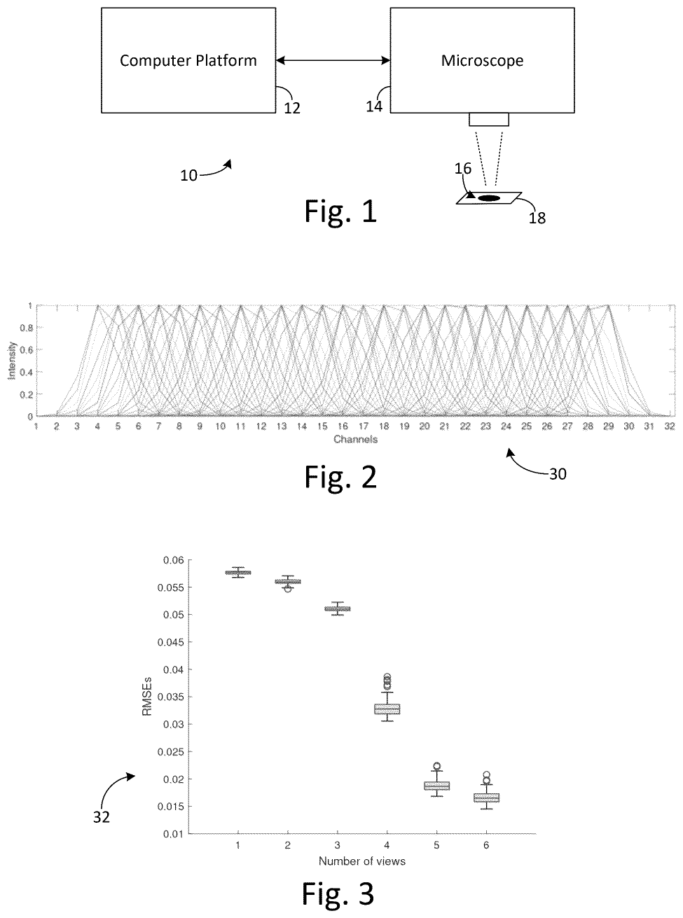

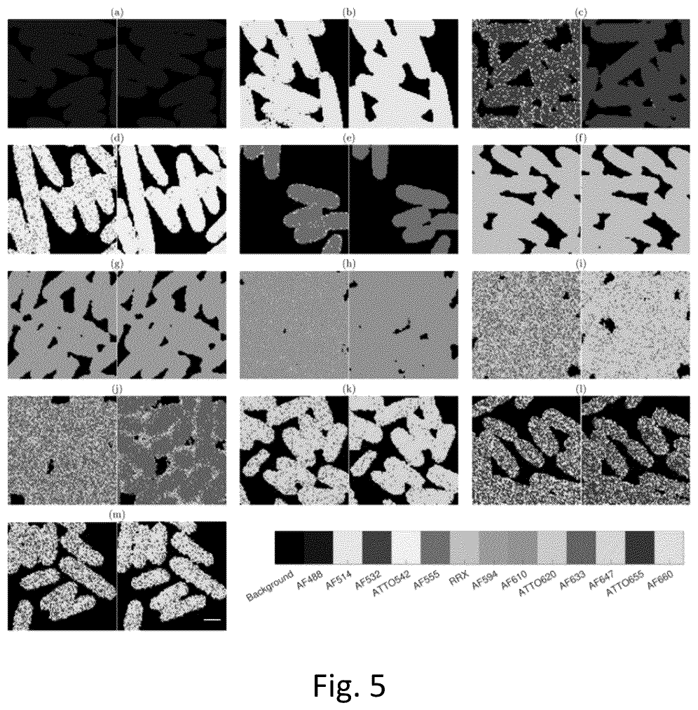

With reference to the figures in which like numerals represent like elements throughout the several views, FIG. 1 is a system 10 for spectral unmixing of fluorophores in an image of a biological sample 16 including a computer platform 12, which has at least one processor that configured to implement a learning model as further described herein. The learning model is tuned using a training series of bacterial fluorophore images, such as those shown in FIG. 5, and the learning model producing an endmember matrix of excitation wavelengths, such as shown in FIG. 2 for each fluorophore in each of the training series of bacterial fluorophore images (FIG. 5). There is a microscope 14 providing at least one diagnostic image of bacterial fluorophores to the at least one processor at the computer platform 12. Here, the upon receiving the diagnostic image of the biological sample 18, which here is on a slide 18, the at least one processor performs spectral unmixing on the at least one diagnostic image by extracting an endmember of each fluorophore from the endmember matrix produced by the training series (FIG. 5), and using the extracted endmembers (FIG. 2) to learn abundances in a multi-view spectral image of the at least one diagnostic image.

The microscope 14 can be a microscopic imager integrated with the computer platform 12, or can be remotely located from the computer platform 12. According, the system 10 can be physically integrated into a singe device. Furthermore, while shown here as a biological sample 16 on a slide 18, the diagnostic image can be obtained with any know method of producing diagnostic images as known to one of skill in the art.

The training series of bacterial fluorophore images (FIG. 5) can be recorded at different views of bacteria. The processor can further perform linear unmixing of the diagnostic image with a Multi-View Linear Mixture Model (MV-LMM) as described herein. Further, the learning model can be further tuned by an Alternating Direction Method of Multipliers (ADMM) technique. And the extracting an endmember of each fluorophore from the training series is extracting the endmember through a multi-view machine learning scheme.

The processor can further perform a loss function within extracting the endmember, the loss function from one or both of a Poisson loss and an expectile loss, as described herein. The processor can be further configured to perform single-view learning in the learning model. Additionally, the processor can further perform single-view learning by using a Matrix Factorization Algorithm for endmember extraction and then using a Nonnegative Least Squares (NLS) unmixing method for abundance estimation, as described herein. The endmembers can be generated using a Gaussian distribution, as shown in FIG. 2. Additionally, the training series of bacterial fluorophore images can be comprised of a plurality of pixels and the processor can further determine, per pixel, if an estimated abundance of a corresponding fluorophore is more than that of all other fluorophores.

The present invention works with numerous biological systems that exhibit intricate interactions among various subcomponents, where fluorescent labels are often employed to indicate the spatial distribution of these components within cells and tissues. Spectral imaging microscopes (such as mic record fluorescence intensity data in discrete wavelength bands at each pixel, enabling the creation of a 3-dimensional data cube that integrates spatial and spectral information from the sample. While many spectrally variant fluorescent reporters are suitable for biological imaging, available fluorophores have broad excitation and emission spectra which makes distinguishing their individual contributions at every pixel a major challenge.

When there is overlap in the excitation and emission spectra of fluorophores, a single excitation wavelength band may excite more than one fluorophore and the emitted signals from different fluorophores can be recorded in the same emission bands. These phenomena is known as cross-talk and bleedthrough lead to inaccurate classification and quantification of signals from different fluorophores and thus hampers the ability to localize specific biological structures or molecules within cells and tissues. To overcome these issues, spectral imaging acquisition and analysis techniques, especially spectral unmixing methods, have been developed. These approaches aim to extract the spectral signatures of fluorophores from recorded images and determine the abundance of each fluorophore in every pixel of an image. However, from a machine learning perspective, existing methods essentially represent single-view learning where models are trained and predictions are made based on a single group of features that describes the field of interest, i.e., the emitted spectral profile of the fluorophores. However, organic fluorophores have not only unique emission spectral signatures but also possess unique excitation spectral profiles. By recording the emission spectra with multiple combinations of excitation wavelengths in the same field, one can obtain multi-view data, each view of which can be considered as a distinct feature group of the field.

Accordingly, multi-view learning in the context of biological spectral unmixing by leveraging complete emission spectra obtained with various combinations of excitation wavelengths as a rich source of information on fluorophore distribution. The present invention can significantly enhance the ability to discriminate fluorophores with highly overlapping spectra while allowing for a substantial expansion in the number of different fluorophores that can be employed and discriminated in a single experiment as their broad spectra lead to crowding and extensive bleed-through in the limited visible wavelength range.

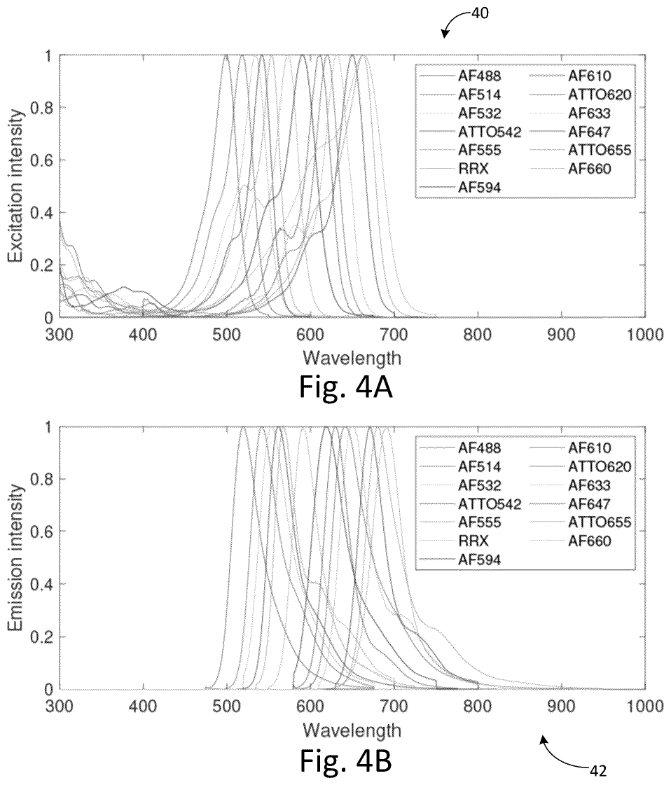

Within the context of biological spectral unmixing, one can make use of both excitation spectra and emission spectra (see FIGS. 4A-4B). For instance, emission spectra at multiple excitation wavelengths can help distinguish 16 different fluorophores. Fluorophores absorb light energy at specific wavelengths and only emit light at longer wavelengths, and consequently, signals with emission wavelengths shorter than an excitation wavelength are excluded, which may lead to insufficient exploration of the multi-view data.

Here, the system 10 makes full use of the acquired multi-view image data to train learning machines. In particular, the present framework for multi-view learning in biological spectral unmixing is essentially a form of regularized learning that allows the incorporation of various noise, spatial, and sparsity constraints or other types of prior information about the fluorescent image.

To demonstrate the efficacy of the present invention, samples were made: E. coli K12 (ATCC 10798) cells were grown to mid-log phase in Luria-Bertani LB Broth (Difeo Laboratories, Inc.). E. coli cultures were fixed in 2% paraformaldehyde (EMS Diasum) at room temperature, then stored in 50% ethanol for at least 24 hours before FISH labeling. E. coli cells were labeled with the general bacteria probe, EUB338 (GCTGCCTCC-CGTAGGAGT) conjugated to a fluorescent dye at the 5′ end.

Spectral images were acquired on a Zeiss LSM 980 confocal microscope with 32 anode spectral detector and a 63× 1.4 NA objective. Single-view images for comparison were acquired with a single combination of 488 nm, 561 nm, and 639 nm laser excitation wavelengths and multi-pass main beam splitter. The images were collected on the 32-anode spectral detector with 9.8 nm width spectral resolution in each channel. Multi-view images were acquired separately in the descending order of the excitation laser light wave-lengths: 639 nm, 594 nm, 561 nm, 514 nm, 488 nm, and 445 nm. The number of channels with different excitation wave-lengths or views are listed in Table 1.

TABLE 1

| | | | | | | | |
|---|---|---|---|---|---|---|---|
| Laser (nm) | 445 | 488 | 514 | 561 | 594 | 639 | 488/561/639 |
| Channels | 28 | 24 | 21 | 15 | 12 | 7 | 24 |

Table 1 shows the number of channels with different excitation wavelengths. 488/561/639 represents the image recorded with a combination of 488 nm, 561 nm, and 639 nm laser excitation wavelengths.

Images were captured in a descending order of excitation laser light wavelengths, a strategic approach aimed at minimizing fluorophore bleaching. Because both the reference spectra and the unknown samples are recorded in the same sequence, moving from the longest to the shortest excitation wavelength, the impact of bleaching artifacts is minimized, as both the reference spectra and the unknown samples exhibit similar bleaching dynamics.

To minimize artifacts imposed by acquiring images with different main beam splitters, align the images into one coordinate system using an intensity-based image registration algorithm (32). This algorithm optimizes the similarity be-tween the images of the same field of interest through a 2D geometric transformation.

To implements multi-view learning for biological spectral unmixing, a common assumption in spectral unmixing is that the signals recorded from various fluorophores within a pixel combine linearly. Linear spectral unmixing separates each pixel into its spectral signatures, referred to as endmembers, and their associated abundances.

Consider multi-view spectral images captured from the same field of interest, denoted as

$${\{ {Y}_{i} \}}_{i = 1}^{I} ∈ {ℝ}_{+}^{{C}_{i} \times N} .$$

These images comprise Ci channels and N pixels, obtained at I different combinations of excitation wavelengths. Let

$${M}_{i} ∈ {ℝ}_{+}^{{C}_{i} \times R}$$

represent the endmember matrix associated with R fluorophores for the i-th combination of excitation wavelengths or the i-th view, and A∈ [symbol] +^{R×N} be the corresponding abundance matrix.

To accommodate such multi-view data in a linear unmixing context, we propose the following Multi-View Linear Mixture Model (MV-LMM):

$${Y}_{i} = {M}_{i} A + {ε}_{i} , i = 1 , … , I ,$$

where εi∈ [symbol] ^{Ci×N} represents the unknown noise matrix from the i-th view. It reduces to the commonly used linear mixture model when I=1, which corresponds to the scenario where only single-view data is available.

As is a common strategy in biological spectral imaging, one can assume the availability of reference samples, each of which consists of a single fluorophore. There is a two-step process of multi-view spectral unmixing, where the first step is to extract the endmember of each fluorophore from the reference spectral images recorded at different views, and the second step is, by using the extracted endmembers, to learn the abundances in a multi-view spectral image. A mathematical description of our proposed two-step approach can be detailed as follows:

For the multi-view learning for endmember extraction, denoting the multi-view reference images of a fluorophore recorded at different views as

$${\{ {Y}_{i}^{′} \}}_{i = 1}^{I} ∈ {ℝ}_{+}^{{C}_{i} \times N}$$

the endmember can be extracted through a multi-view machine learning scheme:

$${min}_{{m}_{i} ∈ {ℝ}_{+}^{{C}_{i}} , a ∈ {ℝ}_{+}^{N}} {\sum }_{i = 1}^{I} {w}_{i} ℓ ( {Y}_{i}^{′} , {m}_{i} {a}^{T} ) ,$$

where mᵢ represents the endmember at the i-th view, a is the corresponding abundance vector, vector, {wᵢ}^{I}ᵢ₌₁ are the weights of different views, and [symbol] is a loss function.

For the multi-view learning for abundance estimation, recall that the endmember matrix Mᵢ consists all fluorophores at the i-th view. Based on {Mᵢ}^{I}ᵢ₌₁ obtained from Step 1, in this step, we learn the abundances of the fluorophores in a given multi-view image set

$${\{ {Y}_{i} \}}_{i = 1}^{I} ∈ {ℝ}_{+}^{{C}_{i} \times N}$$

recorded at I views from the same field of interest. To this end, we propose the following multi-view machine learning method for abundance estimation:

$${min}_{A ≽ 0} {\sum }_{i = 1}^{I} {w}_{i} ℓ ( {Y}_{i} , {M}_{i} A ) + λΩ ( A ) ,$$

where λ is a tuning parameter and Ω(A) represents a penalty term imposed on A. Note that the weights of different views {wᵢ}^{I}ᵢ₌₁ and the loss function [symbol] can be different from those for the endmember extraction method.

This framework of multi-view machine learning effectively accommodates diverse prior information. For instance, the weights {wᵢ}^{I}ᵢ₌₁ can be determined based on the varying importance of different views within specific applications. The choice of the loss function depends on the characteristics of the data. It can be selected as Poisson loss by assuming the presence of Poisson noise, expectile loss when dealing with asymmetric noise distribution, or other robust losses for highly noisy data. The penalty term offers flexibility and can be chosen as the [symbol] ₁ norm and its variants to promote sparsity, nuclear norm to limit rankness, total variation for smoothing neighboring pixels, or a combination of several penalties. The parameter A serves as the balancing factor, regulating the trade-off between the fidelity term and the penalty term.

The effectiveness of our proposed multi-view learning by comparing it with a commonly used single-view learning approach, utilizing the combination of 488 nm, 561 nm, and 639 nm laser excitation wavelengths. To maintain fairness and simplicity in the comparison, we set the weights in as equal and opt for the least squares loss function with no penalty term which eliminates the need for a tuning process. Then the equation is expressed as:

$${min}_{{m}_{i} ∈ {ℝ}_{+}^{{C}_{i}} , a ∈ {ℝ}_{+}^{N}} {\sum }_{i = 1}^{I} {‖ {Y}_{i} - {m}_{i} {a}^{T} ‖}_{F}^{2} ,$$

where ∥·∥_{F} represents the Frobenius norm. And the equation is then formulated as:

$${min}_{A ≽ 0} {\sum }_{i = 1}^{I} {‖ {Y}_{i} - {M}_{i} A ‖}_{F}^{2} .$$

Both optimization problems can be addressed using an Alternating Direction Method of Multipliers (ADMM) technique to ensure efficient and effective solutions. For single-view learning, one can employ a Non-negative Matrix Factorization (38) algorithm for endmember extraction and the Non-negative Least Squares (NLS) unmixing method for abundance estimation.

To assess the performance of our proposed methods across varying numbers of views in the presence of numerous highly overlapping end-members, we generated 100 endmembers using a Gaussian distribution with 24 channels, as depicted in FIG. 2. The correlation coefficient between any two adjacent endmembers is 0.973, indicating significant spectral overlap. With these endmembers, we simulated 1000 spectral images, each comprising 1000 pixels. Within each pixel, the abundance of one random endmember was generated from a uniform distribution U(0, 1), while the abundances of the remaining endmembers were set to zero. Additionally, the endmembers were modified by randomly generated excitation intensities, which follow a uniform distribution U[0, 1]. To simulate real-world conditions, Poisson noise with a signal-to-noise ratio (SNR) of 5 and Gaussian noise with an SNR of 40 were introduced into the generated data.

FIG. 2 is graph 30 of 100 endmembers with 32 channels created through a Gaussian distribution. FIG. 2 shows 100 endmembers with 32 channels were created through a Gaussian distribution characterized by close means and a standard deviation of 0.5. Each line represents a distinct endmember.

To evaluate the accuracy of unmixing with N pixels and R endmembers, one can employ the Root Mean Square Error (RMSE) criterion, defined as follows:

$${RMSE}_{A} ( \hat{A} ) = \sqrt{\frac{{‖ A - \hat{A} ‖}_{F}^{2}}{NR}} ,$$

where A represents the simulated abundance matrix, which serves as the ground truth, and Â denotes the estimated abundance matrix. The RMSE criterion measures the dissimilarity between the true abundance matrix and the estimated abundance matrix.

FIG. 3 is a graph 32 of boxplots of Root Mean Square Errors (RMSEs) of unmixing results. FIG. 3 presents the boxplots of RMSEs obtained from simulations with varying numbers of views. The RMSEs exhibit a decreasing trend as the number of views increases. The average RMSEs show a significantly lower value with a higher number of views compared to cases with a lower number of views. Boxplots of Root Mean Square Errors (RMSEs) were derived from simulations involving varying numbers of views. Each RMSE was assessed based on the unmixing results obtained from simulated spectral images, where the number of views corresponds to the quantity of simulated spectral images.

To demonstrate the efficacy of the present invention, an assessment of multi-view learning performance was conducted on real biological images of fluorescently labeled E. coli cells. E. coli cells were labeled in a fluorescence in situ hybridization (FISH) procedure with the general bacterial probe. Twelve versions of the same oligonucleotide FISH probe were synthesized, each version conjugated to a different fluorophore endmember, characterized by significant overlapping excitation and emission spectra, as illustrated in FIGS. 4A-4B.

FIG. 4A is a graph 40 of standardized overlapping excitation spectra of 12 Fluorophores. FIG. 4B is a graph 42 of standardized overlapping emission spectra of 12 Fluorophores. In FIGS. 4A-4B, standardized overlapping excitation and emission spectra of 12 Fluorophores, with AF representing Alexa Fluor and RRX denoting Rhodamine Red-X. Endmember spectral profiles were extracted from their corresponding multi-view reference images from reference images of pure populations of the E. coli, each population labeled with only one version of the FISH probe. Then the abundances of these fluorophores were reconstructed from an additional set of reference images. It was assumed, during the unmixing process, that all endmembers were present in each image, despite only a single endmember existing in each reference image.

To evaluate the unmixing results, a pixel in a reference image is correctly identified if the estimated abundance of the corresponding fluorophore is more than that of all other fluorophores. To visually represent the performance of the unmixing results, each of the twelve fluorophores was assigned a distinct color. For every pixel, the color of the fluorophore with the highest calculated abundance among all fluorophores was assigned to that pixel. This color assignment scheme facilitated a clear and intuitive depiction of the dominant fluorophore in each pixel, thereby providing a visual representation of the unmixing results. The estimated abundances of the twelve reference images, obtained through our proposed multi-view learning and the single-view learning, are presented in FIG. 5, respectively.

FIG. 5 is a series of reference images of abundances. Abundances of reference images of: (a) AF488, (b) AF514, (c) AF532, (d) ATTO542, (e) AF555, (f) RRX, (g) AF594 (h) AF610, (i) ATTO620, (j) AF633, (k) AF647, (l) ATTO655, and (m) AF660 estimated by (left of all pairs) single-view learning and (right of all pairs) multi-view learning. The white rectangular bar in the lower right corner of the right image of image (m) represents a scale of 1 μm. Each pixel's color corresponds to the fluorophore with the highest estimated abundance, as indicated by the legend with AF representing Alexa Fluor and RRX denoting Rhodamine Red-X.

As depicted in FIG. 5, the present method exhibits superior accuracy, with a greater number of correctly identified pixels compared to the single-view learning. Notably, in image (c) of FIG. 5, the multi-view learning for AF532 demonstrates a significantly better outcome than the corresponding single-view learning. This improvement is attributed to the substantial excitation intensity of AF532 at wavelengths 488 nm, 514 nm, and 532 nm. Despite the reduction in number of channels with increasing wavelength, the rich information from multi-view learning aids in effectively distinguishing AF532 from other highly overlapping fluorophores. Despite the utilization of six excitation wavelengths respectively, the number of views for each fluorophore is not as extensive due to the limited range of nonzero excitation spectra and the reduction in number of channels. Consequently, in image (k) of FIG. 5, multi-view learning for the very long wavelength ATTO655 yields a result similar to that of single-view learning.

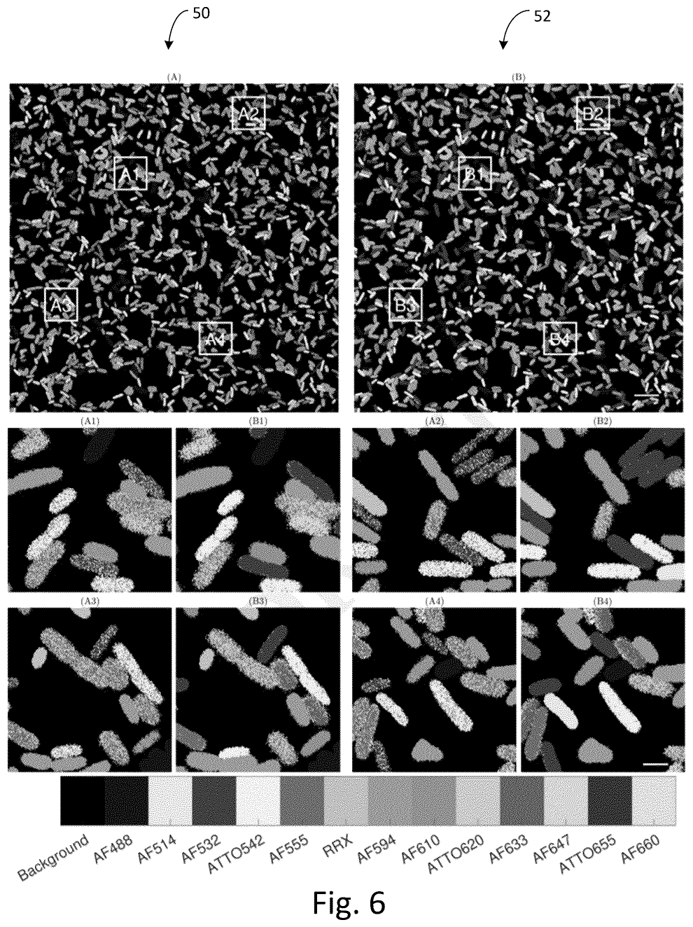

We proceeded to reconstruct the abundances of the fluorophores in a mixture sample of E. coli cells, characterized by similar morphology as the reference samples. The estimated abundances obtained through multi-view learning and single-view learning are visualized in FIG. 6. FIG. 6 is a series of images of abundances of mixed E. Coli spectral images. Abundances of mixed E. coli spectral image estimated by row 50 (reference (A)) single-view learning and row 53 (reference (B)) multi-view learning. (A1)-(A4) are magnified views of the regions within the four white boxes in (A) and (B1)-(B4) are magnified views of the regions within the four white boxes in (B). The white rectangular bar in the lower right corner of (B4) represents a scale of 2 μm. Each pixel's color corresponds to the fluorophore with the highest estimated abundance, as indicated by the legend with AF representing Alexa Fluor and RRX denoting Rhodamine Red-X.

Notably, the abundance matrix derived from multi-view learning reveals distinct oval shapes, each corresponding to the same color or the highest abundance of a specific fluorophore. This contrasts with the abundance matrix obtained through single-view learning.

Thus, a multi-view machine learning framework is created to effectively differentiate fluorophores with significant spectral overlap. The multi-view data was acquired by recording the emission spectra with various combinations of excitation wavelengths. Through the multi-view machine learning approach, one can perform endmember extraction and abundance estimation using the above equations.

The present approach demonstrates exceptional accuracy in estimating fluorophore abundances, particularly for those with highly overlapping emission spectra, through the application of multi-view learning. Simulated data results highlighted that incorporating more views led to more accurate unmixing outcomes. The unmixed real biological spectral images further underscored the efficacy of our proposed approach. Note that the simulation utilized only 100 endmembers as an example, and the approach can handle a variable number of endmembers as required.

It is important to note that least squares unmixing methods were used for their simplicity and computational efficiency. However, other data fidelity terms tailored to the specific dataset could be considered. Additionally, the constraints on abundances may be applied based on the particular requirements of the application. As a first approach, the multi-view framework incorporates multiple discrete wavelength excitations as different views of the data because it is well appreciated that organic fluorophores have unique excitation and emission spectra. As a framework the approach presented here could incorporate other types of data as different views of the endmembers including fluorescence lifetime information and other characteristics that are unique to each endmember used in any single biological fluorescence imaging experiment.

In sum, it can be seen that the above steps provide an inventive method of a method for spectral unmixing of fluorophores in an image (e.g. FIG. 6) of a biological sample 16 with the steps of tuning a learning model using a training series of bacterial fluorophore images (FIG. 5), with the learning model producing an endmember matrix of excitation wavelengths for each fluorophore (FIG. 2) in each of the training series of bacterial fluorophore images (FIG. 5), and then providing at least one diagnostic image of bacterial fluorophores (FIG. 6) from a microscope 14. The method continues by extracting an endmember of each fluorophore from the endmember matrix produced by the training series (FIG. 2) and then using the extracted endmembers to learn abundances in a multi-view spectral image of the at least one diagnostic image (FIG. 6). These steps can be performed on the computer platform 12, or on a plurality of computer devices in wired or wireless communication, or across a network.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of one or more aspects of the invention and the practical application, and to enable others of ordinary skill in the art to understand one or more aspects of the invention for various embodiments with various modifications as are suited to the particular use contemplated.

What is claimed is:

1. A system for spectral unmixing of fluorophores in an image of a biological sample, comprising:
a computer platform having at least one processor configured to implement a learning model, the learning model tuned using a training series of bacterial fluorophore images, the learning model producing an endmember matrix of excitation wavelengths for each fluorophore in each of the training series of bacterial fluorophore images; and
a microscope providing at least one diagnostic image of bacterial fluorophores to the at least one processor at the computer platform,
wherein, upon receiving the at least one diagnostic image, the at least one processor further configured to perform spectral unmixing on the at least one diagnostic image by:
extracting an endmember of each fluorophore from the endmember matrix produced by the training series; and
using the extracted endmembers to learn abundances in a multi-view spectral image of the at least one diagnostic image.

2. The system of claim 1, wherein the training series of bacterial fluorophore images are recorded at different views of bacteria.

3. The system of claim 1, wherein the processor further configure to perform linear unmixing of the at least one diagnostic image with a Multi-View Linear Mixture Model (MV-LMM).

4. The system of claim 1, wherein extracting an endmember of each fluorophore from the training series is extracting the endmember through a multi-view machine learning scheme.

5. The system of claim 1, wherein the processor further configured to perform a loss function within extracting the endmember, the loss function from one or both of a Poisson loss and an expectile loss.

6. The system of claim 1, wherein the learning model is further tuned by an Alternating Direction Method of Multipliers (ADMM) technique.

7. The system of claim 1, wherein the at least one processor is further configured to perform single-view learning in the learning model.

8. The system of claim 7, wherein the at least one processor configured to perform single-view learning by:
using a Matrix Factorization Algorithm for endmember extraction; and
using a Nonnegative Least Squares (NLS) unmixing method for abundance estimation.

9. The system of claim 1, wherein endmembers are generating using a Gaussian distribution.

10. The system of claim 1, wherein the training series of bacterial fluorophore images are each comprised of a plurality of pixels and the processor further configured to determine, per pixel, if an estimated abundance of a corresponding fluorophore is more than that of all other fluorophores.

11. A method for spectral unmixing of fluorophores in an image of a biological sample, comprising:
tuning a learning model using a training series of bacterial fluorophore images, the learning model producing an endmember matrix of excitation wavelengths for each fluorophore in each of the training series of bacterial fluorophore images;
providing at least one diagnostic image of bacterial fluorophores from a microscope;
extracting an endmember of each fluorophore from the endmember matrix produced by the training series; and
using the extracted endmembers to learn abundances in a multi-view spectral image of the at least one diagnostic image.

12. The method of claim 11, further recording different views of bacterial fluorophore images of bacteria to create the training series.

13. The method of claim 11, further comprising performing linear unmixing of the at least one diagnostic image with a Multi-View Linear Mixture Model (MV-LMM).

14. The method of claim 11, wherein extracting an endmember of each fluorophore from the training series is extracting the endmember through a multi-view machine learning scheme.

15. The method of claim 11, further comprising performing a loss function within extracting the endmember, the loss function from one or both of a Poisson loss and an expectile loss.

16. The method of claim 11, further comprising tuning the learning model by an Alternating Direction Method of Multipliers (ADMM) technique.

17. The method of claim 11, further comprising performing single-view learning in the learning model.

18. A device that spectrally unmixes fluorophores in an image of a biological sample, comprising:
at least one processor configured to implement a learning model, the learning model tuned using a training series of bacterial fluorophore images, the learning model producing an endmember matrix of excitation wavelengths for each fluorophore in each of the training series of bacterial fluorophore images; and
a microscopic imager providing at least one diagnostic image of bacterial fluorophores to the at least one processor,
wherein, upon receiving the at least one diagnostic image, the at least one processor further configured to perform spectral unmixing on the at least one diagnostic image by:
extracting an endmember of each fluorophore from the endmember matrix produced by the training series; and
using the extracted endmembers to learn abundances in a multi-view spectral image of the at least one diagnostic image.

19. The device of claim 18, wherein the processor further configure to perform linear unmixing of the at least one diagnostic image with a Multi-View Linear Mixture Model (MV-LMM).

20. The device of claim 18, wherein the training series of bacterial fluorophore images are each comprised of a plurality of pixels and the processor further configured to determine, per pixel, if an estimated abundance of a corresponding fluorophore is more than that of all other fluorophores.
